(19) United States
(12) Patent Application Publication
(10) Pub. No.: US 2014/0247700 A1
(43) Pub. Date: Sep. 4, 2014

(54) Electronic Timepiece and Time Correction Method of Electronic Timepiece

(71) Applicant: Seiko Epson Corporation, Tokyo (JP)

(72) Inventor: Katsuyuki Honda, Nagano-ken (JP)

(73) Assignee: Seiko Epson Corporation, Tokyo (JP)

(21) Appl. No.: 14/191,814

(22) Filed: Feb. 27, 2014

Related U.S. Application Data
(60) Provisional application No. 61/771,313, filed on Mar. 1, 2013.

(30) Foreign Application Priority Data
Mar. 1, 2013 (JP) 2013-040418

(51) Int. Cl. G04G 9/00; G04G 7/00; G04G 5/00

(52) U.S. Cl. CPC G04G 9/0076; G04G 5/002; G04G 7/02
USPC 368/21

(57) ABSTRACT

An electronic timepiece includes a timing unit that receives a satellite signal transmitted from a positioning information satellite and acquires time information; a positioning unit that receives the satellite signal transmitted from the positioning information satellite and acquires positioning information of a current location; a time zone setting unit that sets time zone information based on the positioning information of the current location which is acquired by the positioning unit; a time display unit that has at least a first time display unit for displaying a first time and a second time display unit for displaying a second time; and a time zone correction unit that corrects the first time using the time zone data and that does not correct the second time using the time zone information, if the time zone setting unit sets the time zone information.

### BACKGROUND

1. Technical Field

The present invention relates to an electronic timepiece and a time correction method of an electronic timepiece that receives a satellite signal transmitted from a positioning information satellite and corrects display time.

2. Related Art

An electronic timepiece has been known which receives a satellite signal transmitted from a global positioning system (GPS) satellite and performs time correction (for example, refer to JP-A-2011-75541 (Patent Document 1)).

Patent Document 1 discloses an electronic timepiece including a first time display unit for displaying local time and a second time display unit for displaying home time.

Incidentally, in the electronic timepiece, Patent Document 1 does not disclose how to control time display on the first time display unit and the second time display unit when a current location is changed.

In contrast, an electronic timepiece has been known which receives a satellite signal transmitted from a GPS satellite and corrects time zone data (for example, JP-A-2012-198100 (Patent Document 2)).

In the electronic timepiece including the first time display unit and the second time display unit as disclosed in Patent Document 1, if the time zone data is corrected as in the electronic timepiece disclosed in Patent Document 2, both of the time zone data for the first time display unit and the time zone data for the second time display unit are corrected, thereby causing a problem to a user.

For this reason, a highly convenient electronic timepiece has been required which enables the user to easily recognize multiple different time displays such as the local time and the home time.

### SUMMARY

An advantage of some aspects of the invention is to provide an electronic timepiece which can display multiple different time displays, which enables a user to easily understand the displays, and which can improve convenience.

An aspect of the invention is directed to an electronic timepiece including a positioning unit that receives a satellite signal transmitted from a positioning information satellite and acquires positioning information of a current location; a time display unit that has at least a first time display unit for displaying a first time and a second time display unit for displaying a second time; and a time zone correction unit that corrects the first time using time zone information corresponding to the positioning information and that does not correct the second time using the time zone information.

The electronic timepiece of the aspect of the invention includes multiple time display units having at least the first time display unit and the second time display unit. Therefore, the first time display unit can display a time of the current location (local time: the first time) and the second time display unit can display a time of a place where a user wants to know the time (home time: the second time), such as the user's family living place and the user's working place when traveling abroad.

Then, if the positioning unit acquires the positioning information of the current location and a time zone setting unit sets the time zone information of the current location, the time zone correction unit corrects the first time by using the time zone information. Here, the time zone information is generally time difference information with respect to Coordinated Universal Time (UTC), and the first time display unit displays the first time obtained by correcting UTC using the time zone information. Accordingly, if the user wearing the electronic timepiece travels to a country having a different time zone by plane or the like and acquires the positioning information using the positioning unit, the time zone setting unit sets new time zone information and the time zone correction unit corrects the first time using the set time zone information. Accordingly, the first time display unit can display the first time, that is, the local time of the current location.

In contrast, the time zone correction unit does not correct the second time, even if the time zone information is set. Therefore, the second time can always display the home time.

Accordingly, when traveling to a country having a different time zone, the positioning unit receives the satellite signal and acquires the positioning information, thereby enabling the first time display unit to easily display the local time of the current location. In contrast, the second time display unit always displays the home time set by the user. Thus, even when traveling abroad, it is possible to easily confirm the time of the user's hometown.

It is preferable that the electronic timepiece of the aspect of the invention includes a timing unit that receives the satellite signal transmitted from the positioning information satellite and acquires time information, and a time correction unit that corrects the first time and the second time if the timing unit acquires the time information.

When the timing unit receives the satellite signal and acquires the time information, not only the first time but also the second time can be corrected in conjunction with each other. Therefore, it is possible to accurately adjust the time displayed on the first and second time display units. For this reason, it is possible to enhance accuracy in the time display of the first and second time display units. Furthermore, the time information can be acquired if one positioning information satellite can be captured so as to receive the satellite signal. Accordingly, as compared to an acquisition process of the positioning information which needs to capture three or more positioning information satellites, the acquisition process is shortened, thereby enabling current consumption to be saved.

It is preferable that the second time display unit has a display area which is smaller than that of the first time display unit.

If the display area of the first time display unit is set to be larger than that of the second time display unit, the first time to be corrected by the acquired time zone information, that is, the local time can be easily and visibly checked. Therefore, it is possible to provide a convenient electronic timepiece.

It is preferable that the electronic timepiece of the aspect of the invention includes a display switching unit that switches over the time information displayed by the first time display unit and the time information displayed by the second time display unit to each other.

The display switching unit is executed by the user operating an operation unit such as a button. For example, when the user wearing the electronic timepiece travels from Tokyo, Japan to New York, USA by plane, if the positioning unit acquires the positioning information in Tokyo, the time zone setting unit sets the time zone information in Japan (JST: plus nine hours which is the time difference information with respect to UTC). Therefore, the first time is corrected to Japan Standard Time by the time zone correction unit.

When traveling to New York by plane, if the display switching unit switches over the time information, Japan Standard Time is displayed on the second time display unit. Then, if the positioning unit acquires the positioning information in New York, the time zone setting unit sets the time zone information of east America (EST: minus five hours which is the time difference information with respect to UTC, minus four hours for summer time). Therefore, the second time is corrected to Eastern Standard Time of America by the time zone correction unit.

Therefore, the local time after travelling and the home time before travelling can be accurately and simultaneously displayed on the first time display unit and the second time display unit. Furthermore, when returning back from New York to Tokyo, the display switching unit is operated so as to switch over to the first time display unit to Japan Standard Time. In this manner, the second time display unit can be switched over to Eastern Standard Time of America. Therefore, without receiving the satellite signal, the time when returning to Japan can be displayed on the first time display unit, thereby improving convenience for the user.

It is preferable that the electronic timepiece of the aspect of the invention includes a second time correction unit that corrects the second time displayed by the second time display unit so as to be the first time displayed by the first time display unit.

The second time correction unit is executed by the user operating an operation unit such as a button. For example, if the positioning unit acquires the positioning information in Japan, the time zone setting unit sets the time zone information in Japan (JST: plus nine hours which is the time difference information with respect to UTC). Therefore, the first time is corrected to Japan Standard Time by the time zone correction unit.

Then, if the second time is renewed to the first time by the second time correction unit, the second time is also set to Japan Standard Time. This enables the second time, that is, the home time to be accurately set without a need for manual correction. Then, after travelling to a country having the different time zone, if the positioning unit acquires the positioning information, the time zone setting unit sets the time zone information and time zone correction unit corrects the first time, the first time can be easily corrected to the local time of the current location.

Another aspect of the invention is directed to a time correction method of an electronic timepiece that has at least a first time display unit for displaying a first time and a second time display unit for displaying a second time. The method includes receiving a satellite signal transmitted from a positioning information satellite and acquiring positioning information of the current location; and correcting the first time using time zone information corresponding to the positioning information and not correcting the second time using the time zone information.

In the aspects of the invention, it is possible to achieve an operational effect the same as that of the electronic timepiece. That is, when travelling to a country having the different time zone, the satellite signal is received and the positioning information is acquired, thereby enabling the first time display unit to easily display the local time of the current location. In contrast, the second time display unit always displays the home time set by the user. Thus, even when travelling abroad, it is possible to easily confirm the time of the user's hometown.

### BRIEF DESCRIPTION OF THE DRAWINGS

The invention will be described with reference to the accompanying drawings, wherein like numbers reference like elements.

FIG. 1 is a front view illustrating an electronic timepiece of the invention.

FIG. 2 is a schematic cross-sectional view of an electronic timepiece.

FIG. 3 is a block diagram illustrating a configuration of an electronic timepiece according to a first embodiment.

FIG. 4 is a block diagram illustrating a configuration of a storage device according to the first embodiment.

FIG. 5 is a flowchart illustrating a receiving process in the first embodiment.

FIG. 6 is a flowchart illustrating a receiving process in a positioning mode according to the first embodiment.

FIG. 7 is a flowchart illustrating a receiving process in a second embodiment.

FIG. 8 is a flowchart illustrating a receiving process in a positioning mode according to the second embodiment.

FIG. 9 is a block diagram illustrating a configuration of an electronic timepiece according to a third embodiment.

FIG. 10 is a block diagram illustrating a configuration of a storage device according to the third embodiment.

FIG. 11 is a block diagram illustrating a configuration of an electronic timepiece according to a fourth embodiment.

### DESCRIPTION OF EXEMPLARY EMBODIMENTS

Hereinafter, specific embodiments of the invention will be described with reference to the drawings.

### First Embodiment

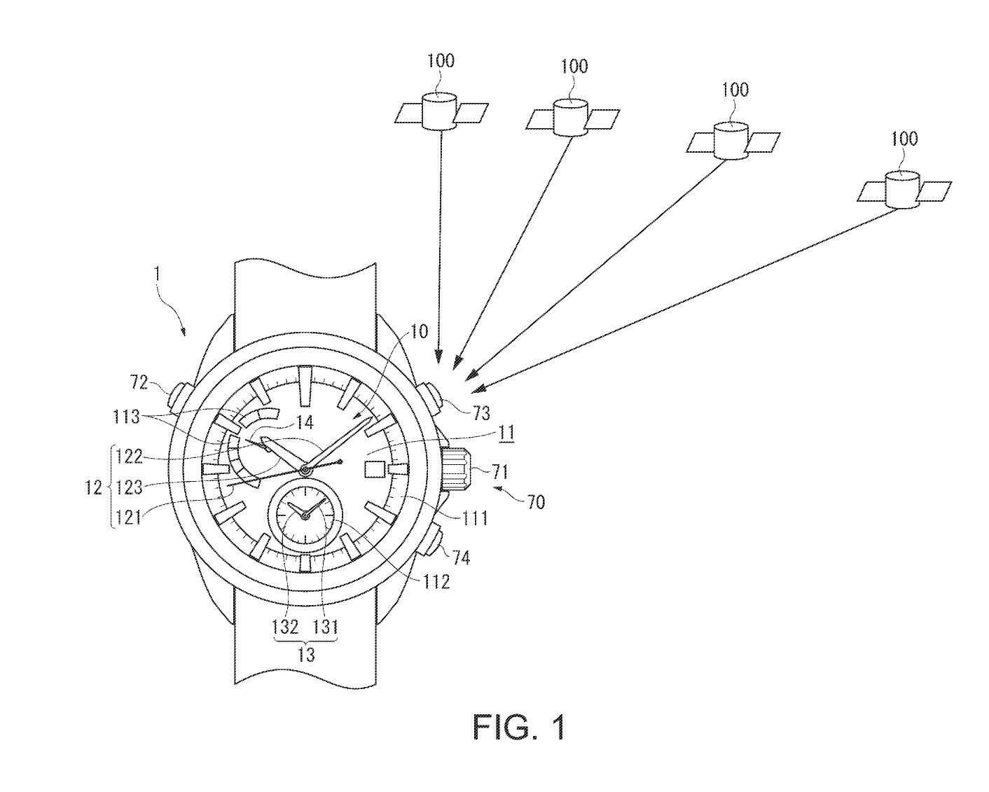

FIG. 1 is a front view illustrating an electronic timepiece 1 according to a first embodiment of the invention.

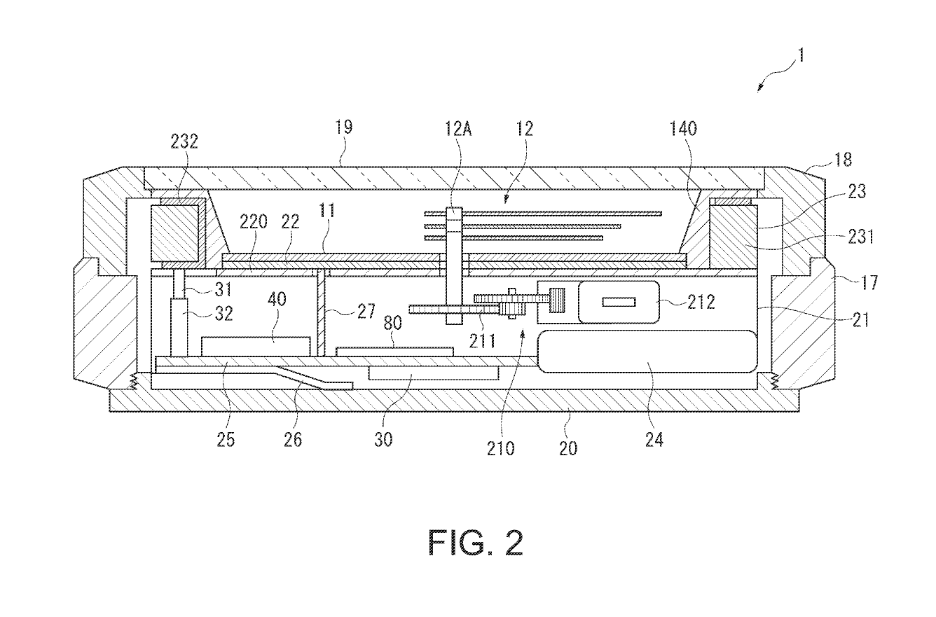

FIG. 2 is a schematic cross-sectional view of the electronic timepiece 1.

As illustrated in FIG. 1, the electronic timepiece 1 receives a satellite signal from at least one GPS satellite 100 out of multiple GPS satellites 100 orbiting the earth in a predetermined orbit in the sky and acquires time information. The electronic timepiece is configured to calculate positioning information by receiving the satellite signal from at least three GPS satellites 100. The GPS satellite 100 is an example of a positioning information satellite, and multiple GPS satellites 100 are present in the sky over the earth. Approximately 30 GPS satellites 100 are currently orbiting the earth.

### Electronic Timepiece

The electronic timepiece 1 is a wristwatch which a user wears on the user's wrist, and includes a display device 10 that displays time or the like and an input device 70.

### Display Device

The display device 10 includes a dial 11, first hands 12, second hands 13 and an indicator hand 14.

The dial 11 is mostly formed of nonmetallic materials to which light and microwave of 1.5 GHz band are likely to be transmitted (for example, plastic or glass).

The dial 11 includes a main dial 111 corresponding to the first hands 12, a sub-dial 112 corresponding to the second hands 13, and a scale 113 corresponding to the indicator hand 14.

The first hands 12 are disposed on a surface side of the main dial 111. The first hands 12 include a second-hand 121, a minute hand 122 and an hour hand 123. The first hands 12 and the main dial 111 configure a first time display unit 110 (basic timepiece) which displays a first time.

The second hands 13 are disposed on a surface side of the sub-dial 112. The second hands 13 include a minute hand 131 and an hour hand 132. The second hands 13 and the sub-dial 112 configure a second time display unit 120 (minor timepiece) which displays a second time.

Accordingly, the electronic timepiece 1 of the present embodiment includes a dual time function which can display the first time and the second time. The second time display unit 120 is set to have a display area smaller than that of the first time display unit 110.

In addition, the indicator hand 14 is disposed on the surface side of the main dial 111, and indicates various information items such as a remaining energy level (battery level).

Although not illustrated, the electronic timepiece 1 includes a hand position detection unit which detects a hand position of the first hands 12. The hand position detection unit includes a light sensor having a light emitting element and a light receiving element and a through hole disposed in a train wheel (gear) of each hand. A known hand position detection unit may be used which is configured so that the light receiving element can receive light transmitted from the light emitting element when the respective hands are aligned in the 12 o'clock position. However, in the electronic timepiece 1, the hand position detection unit of the second hands 13 is not prepared.

The hands 12, 13 and the indicator hand 14 are driven by a step motor via gears. In the present embodiment, there are provided a step motor for driving the minute hand 122 and the hour hand 123 of the first hands 12, a step motor for driving the second-hand 121, a step motor for driving the indicator hand 14, and a step motor for driving the second hands 13 (minute hand 131, hour hand 132). Furthermore, it is preferable to dispose a step motor for driving a date indicator when the date indicator is provided.

### Input Device

The input device 70 includes a crown 71 and three buttons 72, 73 and 74. If the input device 70 is operated, a process is executed according to the manual operation.

Specifically, if the crown 71 is shifted down by one stage, the second hands 13 can be manually corrected. In this state, if the buttons 73 and 74 are pressed, the second hands 13 are moved.

In addition, if the crown 71 is shifted down by two stages, the first hands 12 can be manually corrected. In this state, if the buttons 73 and 74 are pressed, the first hands 12 are moved.

If the button 72 is pressed, a process such as cancellation of various operation modes and a stop of receiving process is executed according to a situation.

If the button 73 is pressed for a first setting period of time (for example, three seconds or longer, shorter than six seconds), a manual receiving process (compulsory receiving process) is executed in a timing mode. In addition, if the button 73 is pressed for a second setting period of time (for example, six seconds or longer) which is longer than the first setting period of time, a manual receiving process (compulsory receiving process) is executed in a positioning mode. Furthermore, if the button 73 is pressed for a period of time shorter than the first setting period of time (for example, shorter than three seconds), a result display process for displaying a result of the previous receiving process is performed.

If the button 74 is pressed, a process is executed in which setting of the time zone is indicated by the second-hand 121.

The processes executed when the respective buttons 72, 73 and 74 are pressed are not limited to the above-description, but may be appropriately set according to functions of the electronic timepiece 1.

### Structure of Electronic Timepiece

As illustrated in FIG. 2, the electronic timepiece 1 includes an outer case 17 made of a metal such as stainless steel (SUS) or titanium. The outer case 17 is formed in a substantially cylindrical shape. A surface glass 19 for covering an opening is attached to the opening of a surface side of the outer case 17 via a bezel 18. The bezel 18 is made of a non-metallic material such as ceramic so as to improve a receiving performance for satellite signals. A case back 20 is attached to an opening of a rear surface side of the outer case 17. The dial 11, a movement 21, a solar panel 22, a GPS antenna 23, and secondary battery 24 are arranged inside the outer case 17.

The movement 21 includes a drive mechanism 210 which drives the display device 10 of the first hands 12, the second hands 13 and the indicator hand 14. The drive mechanism 210 is configured to include step motors, a train wheel 211 and a drive circuit which drives the step motors. The step motor is configured to have a motor coil 212, a stator and a rotor, and drives the first hands 12 via the train wheel 211 or an oscillating axle 12A.

A circuit board 25 is arranged in the case back 20 side of the movement 21.

A receiving device 30 which processes the satellite signal received by the GPS antenna 23, a control device 40 which performs various controls such as drive controls for the receiving device 30 or the step motors, a charging circuit 80 which charges power generated by the solar panel 22 to the secondary battery 24 are attached to the circuit board 25. The receiving device 30 and the control device 40 are driven by the power supplied from the secondary battery 24.

### Solar Panel

The solar panel 22 is a photovoltaic power generation element which performs photovoltaic power generation for converting light energy into electrical energy. The solar panel 22 includes seven to eight solar cells (not illustrated), and outputs the energy by connecting the solar cells in series.

As illustrated in FIG. 2, the solar panel 22 is supported by a solar panel support substrate 220. For example, the solar panel support substrate 220 is a conductive substrate having a width of 0.1 mm for example, which is formed of a metallic material such as brass (BS), stainless steel (SUS) and titanium alloy. In this manner, the solar panel support substrate 220 functions as a part of the GPS antenna 23 after having a current distribution the same as that of the GPS antenna 23 arranged in close proximity.

The solar panel support substrate 220 is incorporated into the outer case 17 so as not to be in contact therewith. That is, the solar panel support substrate 220 is arranged so that an outer peripheral surface thereof is apart from and is not in contact with an inner peripheral edge of the outer case 17.

The dial 11 and the solar panel 22 are formed so that each outer diameter matches an inner diameter of dial ring 140 and each outer periphery is hidden by the dial ring 140. Accordingly, the solar panel support substrate 220 is not visible from outside. In addition, an outer dimension of the solar panel support substrate 220 is adapted to be larger than the solar panel 22 and the dial 11, and is enlarged to a lower surface position of the GPS antenna 23.

### GPS Antenna

The GPS antenna 23 includes an annular dielectric substrate 231 having a rectangular cross-sectional shape, and is a ring antenna, a surface of which has an antenna electrode 232.

The dielectric substrate 231 is adapted to shorten a wavelength of radio waves and can be configured to have so-called micarex (∈r=6.5 to 9.5), glass (∈r=5.4 to 9.9) and diamond (∈r=5.68) which are ceramics mainly composed of alumina (∈r=8.5) or ceramics mainly composed of mica.

The antenna electrode 232 is formed linearly and integrally with the dielectric substrate 231 by printing conductive metallic elements such as copper or silver on a surface of the dielectric substrate 231, or by bonding the conductive metallic elements such as silver or copper to the surface of the dielectric substrate 231. The antenna electrode 232 may be formed by forming patterns on the surface of the dielectric substrate 231 by means of electroless plating.

A connection pin 31 is in contact with the antenna electrode 232. The connection pin 31 is inserted to a connection base portion 32 having a substantially cylindrical shape. The connection base portion 32 is erected by being connected to a printed circuit on the circuit board 25.

The connection pin 31 and the connection base portion 32 are electrically connected to the receiving device 30 via the printed circuit. In the connection base portion 32, a biasing member such as a coil spring, for example, is disposed in an inner cylindrical portion thereof, and biases the connection pin 31 inserted to the connection base portion 32 against the antenna electrode 232 side. This causes the connection pin 31 to be pressed against a feeding point of the antenna electrode 232. In this manner, even when impact is applied to the electronic timepiece 1 for example, a connection state between the connection pin 31 and the antenna electrode 232 is maintained.

In the present embodiment, the case back 20 made of the conductive material also serves as a ground plate (reflection plate) of the GPS antenna 23. The case back 20 is electrically connected to a ground terminal 26 disposed in the movement 21. The ground terminal 26 is connected to a ground potential of the receiving device 30 of the movement 21. Therefore, the case back 20 is electrically connected to the ground potential of the receiving device 30 via the ground terminal 26, and functions as the ground plate (reflection plate) which reflects the radio waves incident from the surface glass 19 side toward the GPS antenna 23. Since the outer case 17 which has the conductive material and is in contact with the case back 20 is the ground potential, the outer case 17 also functions as the ground plate.

Furthermore, the case back 20 and the outer case 17 are made of the metal. Accordingly, in addition to the function as the ground plate, it is possible to avoid any influence on the GPS antenna 23 when the user wears the electronic timepiece 1 on the arm. That is, if the case is a plastic case, a resonance frequency of the GPS antenna 23 is changed by receiving the influence from the neighboring arm between a wearing state and a non-wearing state. Thus, it is not preferable since there is a difference in performance. However, since the case is made of the metal, it is possible to avoid the influence from the arm by virtue of the shield effect. In the present embodiment, there is little difference in antenna characteristics between the wearing state and the non-wearing state, thereby allowing a stable receiving performance. However, it is also possible to employ the plastic case.

### Secondary Battery

The secondary battery 24 is a power supply device of the electronic timepiece 1, and stores power generated by the solar panel 22.

In the electronic timepiece 1, two electrodes of the solar panel 22 and two electrodes of the secondary battery 24 can be respectively and electrically connected to each other by two conductive coil springs 27. When connected, the secondary battery 24 is charged by the photovoltaic power generation of the solar panel 22. In the present embodiment, a lithium ion secondary battery suitable for portable devices is used as the secondary battery 24. However, a lithium polymer battery or other secondary batteries may be used, and alternatively a rechargeable battery different from the secondary battery (for example, capacitance elements) may be used.

### Circuit Configuration of Electronic Timepiece

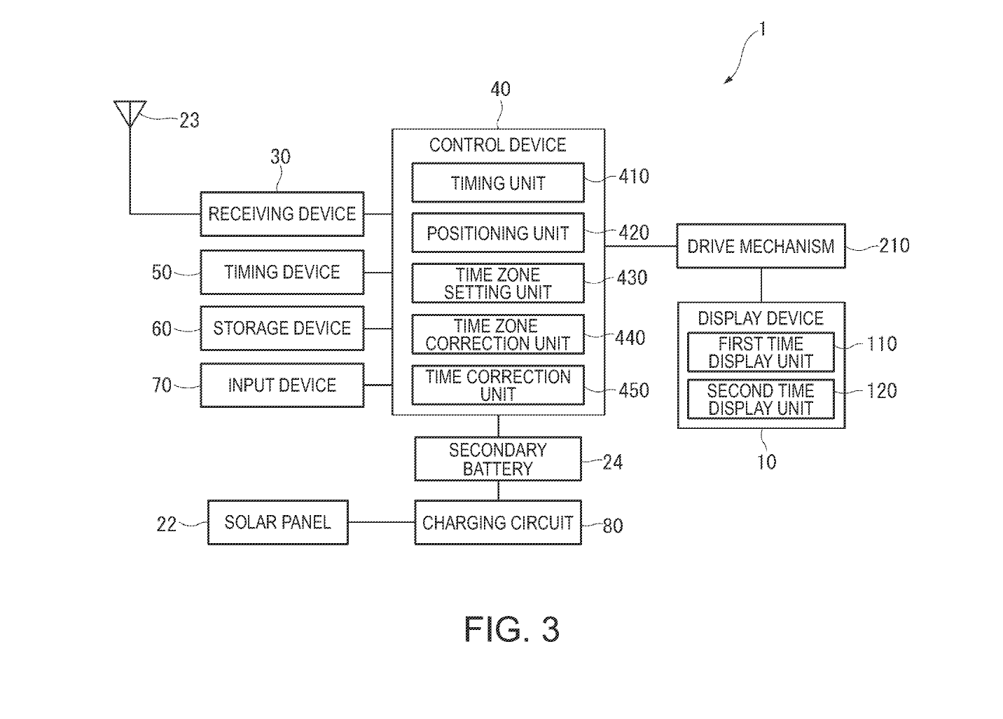

FIG. 3 is a block diagram illustrating a circuit configuration of the electronic timepiece 1. The electronic timepiece 1 includes the receiving device 30 (receiving unit), the control device 40 (control unit), a timing device 50 (timing unit), the storage device 60 (storage unit) and the input device (operation unit).

### Receiving Device

The receiving device 30 is a load driven by the power stored in the secondary battery 24, and when driven by the control device 40, receives the satellite signal transmitted from the GPS satellite 100 through the GPS antenna 23. Then, when successfully receiving the satellite signal, the receiving device 30 transmits the acquired information such as orbit information and GPS time information to the control device 40. In contrast, when failing to receive the satellite signal, the receiving device 30 transmits information indicating the failure to the control device 40. A configuration of the receiving device 30 is the same as a configuration of a known GPS receiving circuit. Therefore, description thereof will be omitted.

### Timing Device

The timing device 50 includes a quartz crystal resonator driven by the power stored in the secondary battery 24, and updates time data by using a reference signal based on a vibration signal of the quartz crystal resonator.

### Storage Device

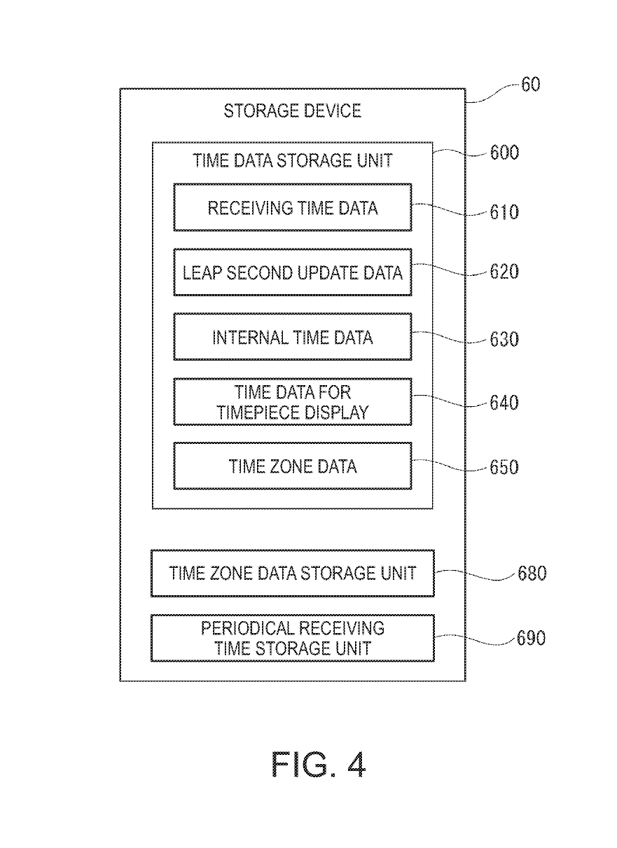

As illustrated in FIG. 4, the storage device 60 includes a time data storage unit 600, a time zone data storage unit 680 and a periodical receiving time storage unit 690.

The time data storage unit 600 stores receiving time data 610, leap second update data 620, internal time data 630, time data for timepiece display 640 and time zone data 650.

The receiving time data 610 stores time information (GPS time) acquired from the satellite signal. The receiving time data 610 is usually updated by the timing device 50 once for every second, and is corrected based on the acquired time information (GPS time) when receiving the satellite signal.

The leap second update data 620 stores at least current leap second data. That is, page 18 in a sub-frame 4 of the satellite signal includes each data item of “current leap second”, “update week of the leap second”, “update date of the leap second” and the “leap second after the update” as the data relating to the leap second. Among them, in the present embodiment, at least the “current leap second” data is stored in the leap second update data 620.

The internal time data 630 stores internal time information. The internal time information is updated by the GPS time stored in the receiving time data 610 and the “current leap second” stored in the leap second update data 620. That is, Coordinated Universal Time (UTC) is stored in the internal time data 630. When the receiving time data 610 is updated in the timing device 50, the internal time information is also updated.

The time data for timepiece display 640 stores time data where the time zone data (time zone information, time difference information) of the time zone data 650 is added to the internal time information of the internal time data 630. The time zone data 650 is set by the positioning information obtained when receiving the positioning information in a positioning mode.

The time zone data storage unit 680 associates the positioning information (latitude and longitude) with the time zone information (time difference information) and stores the information. Therefore, when acquiring the positioning information in the positioning mode, the control device 40 can acquire the time zone data based on the positioning information (latitude and longitude).

The time zone data storage unit 680 may store a city name and the time zone data in association with each other. In this case, if the user selects the city name where the user wants to know the local time by operating the input device 70, the control device 40 may search for the city name set by the user from the time zone data storage unit 680 and may acquire the time zone data corresponding to the city name so as to be set in the time zone data 650.

The periodical receiving time storage unit 690 stores periodical receiving time for executing a periodical receiving process in the timing unit 410. As the periodical receiving time, time which is successfully and compulsorily received by operating the button 73 previously is stored.

### Control Device

The control device 40 is configured to have a CPU for controlling the electronic timepiece 1. The control device 40 includes the timing unit 410, the positioning unit 420, the time zone setting unit 430, the time zone correction unit 440 and the time correction unit 450.

### Timing Unit

The timing unit 410 operates the receiving device 30 and performs the receiving process in a timing mode. In the present embodiment, the receiving process in the timing mode is performed between an automatic receiving process and a manual receiving process.

The automatic receiving process has two types of a periodical automatic receiving process and a light automatic receiving process. That is, when the timed internal time data 630 becomes periodical receiving time stored in the periodical receiving time storage unit 690, the timing unit 410 operates the receiving device 30 and performs the periodical automatic receiving process in the timing mode.

In addition, when it can be determined that a power generation voltage or power generation current of the solar panel 22 is equal to or higher than a setting value and sunlight is emitted to the solar panel 22 outdoors, the timing unit 410 operates the receiving device 30 and performs the light automatic receiving process in the timing mode. The number of processes for operating the receiving device 30 in a power generation state of the solar panel 22 may be constrained to once a day.

Furthermore, when the user presses the button 73 of the input device 70 to perform the compulsory receiving operation, the timing unit 410 operates the receiving device 30 and performs the manual receiving process in the timing mode.

The timing unit 410 causes the receiving device 30 to capture at least one GPS satellite 100 and acquires the time information by receiving the satellite signal transmitted from the GPS satellite 100.

### Positioning Unit

The positioning unit 420, when the user presses the button 73 of the input device 70 to perform the compulsory receiving operation, operates the receiving device 30 and performs the receiving process in the positioning mode.

According to the period of time while the button 73 is pressed, the control device 40 performs a process by switching between the receiving process in the timing mode using the timing unit 410 and the receiving process in the positioning mode using the positioning unit 420. That is, the control device 40 performs the receiving process in the timing mode when the button 73 is pressed for the first setting period of time (three seconds or longer, shorter than six seconds), and performs the receiving process in the positioning mode when the button 73 is pressed for the second setting period of time (longer than six seconds).

If the receiving process in the positioning mode is started, the positioning unit 420 captures at least three GPS satellites 100 (preferably four or more) by the receiving device 30, receives the satellite signal transmitted from each GPS satellite 100, and acquires the positioning information by means of calculation. In addition, when receiving the satellite signal, the positioning unit 420 can also simultaneously acquire the time information.

### Time Zone Setting Unit

When the positioning unit 420 successfully acquires the positioning information, the time zone setting unit 430 sets the time zone data based on the acquired positioning information (latitude and longitude). More specifically, the time zone data (time zone information, that is, time difference information) corresponding to the positioning information is selected and acquired from the time zone data storage unit 680, and is stored in the time zone data 650.

For example, since Japan Standard Time (JST) is nine hours ahead of UTC (UTC+9), when the positioning information acquired by the positioning unit 420 is in Japan, the time zone setting unit 430 reads out the time difference information (plus nine hours) of Japan Standard Time from the time zone data storage unit 680 and stores the time difference information in the time zone data 650.

### Time Zone Correction Unit

When the time zone setting unit 430 sets the time zone information, the time zone correction unit 440 corrects the first time, that is, the time data for timepiece display 640 by using the time zone data. Therefore, the time data for timepiece display 640 is the time in which the time zone data is added to the internal time data 630 which is UTC.

In contrast, the time zone correction unit 440 does not correct the second time by using the time zone information.

### Time Correction Unit

When the time information is successfully acquired by the receiving process of the timing unit 410 or the positioning unit 420, the time correction unit 450 corrects the receiving time data 610 by the acquired time information. Therefore, the internal time data 630 and the time data for timepiece display 640 are also corrected. If the time data for timepiece display 640 is corrected, guiding time of the first hands 12 which is synchronized with the time data for timepiece display 640 by a hand position detection unit is also corrected.

### Operation of Control Device

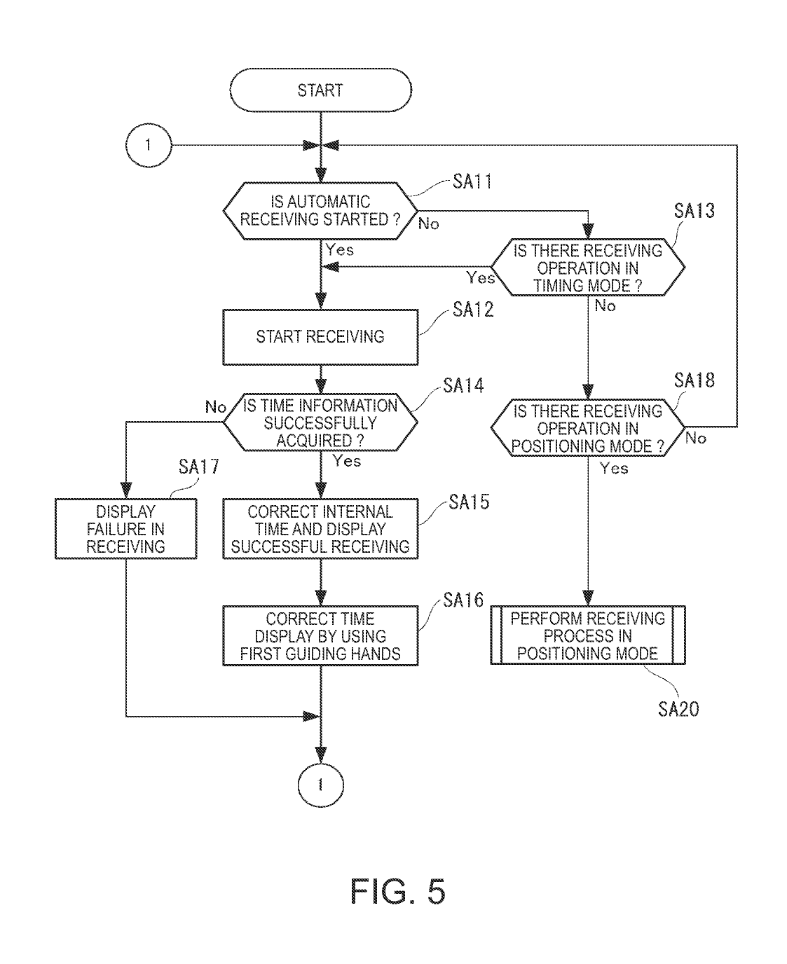

FIG. 5 is a flowchart illustrating the receiving process of the electronic timepiece 1 according to the first embodiment.

If the receiving process is started, the control device 40 determines whether the process is relevant to a condition for starting the automatic receiving (SA11). As described above, when it is the periodical receiving time and when the power generation voltage or current in the solar panel 22 is equal to or higher than the setting value, the control device 40 determines that the process is relevant to the condition for starting the automatic receiving (SA11: YES).

When it is determined Yes in SA11, the timing unit 410 starts the receiving process in the timing mode (SA12).

When it is determined No in SA11, the control device 40 determines whether or not there is the receiving operation in the timing mode where the button 74 is pressed for the first setting period of time (three seconds or longer, shorter than six seconds) (SA13).

When it is determined Yes in SA13, the timing unit 410 starts the receiving process in the timing mode (SA12).

### Receiving Process in Timing Mode

If the receiving process in the timing mode is started in SA12, the timing unit 410 determines whether or not the time information is successfully acquired (SA14).

The receiving device 30 first performs searching to capture the GPS satellite 100. If the GPS satellite 100 is captured, the receiving device 30 receives the satellite signal and acquires the time information. Since the time information is transmitted at intervals of six seconds, the time information can be received by receiving the satellite signal for six seconds. when the time information can be acquired, the control device 40 determines Yes in SA14. In other cases, that is, in a case where the receiving device 30 cannot capture the GPS satellite 100 or in a case where the time information cannot be captured, the control device 40 determines that the acquisition of the time information fails (SA14: No).

### Correction Process of Internal Time in Timing Mode

When it is determined that the time information is successfully acquired (SA14: case of Yes), the control device 40 causes the time correction unit 450 to correct the receiving time data 610 by using the acquired time information, and the internal time data 630 is corrected by being further compensated in the leap second update data 620 (SA15). If the internal time data 630 is corrected, the time data for timepiece display 640 is also corrected by the time zone data 650 which is set.

In addition, the control device 40 displays the success in the receiving by moving the second-hand 121 to a predetermined position via the drive mechanism 210 (SA15). The display of the success in the receiving is performed for a predetermined period of time, for example, five seconds.

If the internal time data 630 is corrected in SA15 and the display of the success in the receiving for the predetermined period of time is completed, the display time using the first hands 12 is also corrected based on the time data for timepiece display 640 (SA16).

After the display time is manually corrected by the buttons 73 and 74, the second hands 13 are operated based on the reference signal using the timing device 50. Therefore, in the second hands 13 which are set to be operated independently from the first hands 12, the display time is not corrected in conjunction with the correction of the display time in the first hands 12.

In contrast, when it is determined No in SA14 (in a case where the receiving fails), the control device 40 does not perform the correction process (SA15) of the internal time, moves the second-hand 121 to a predetermined position via the drive mechanism 210, and displays that the receiving fails (SA17). The display of the failure in the receiving is also performed for a predetermined period of time, for example, five seconds.

If the processes in SA16 and SA17 are completed, the control device 40 returns to the process in SA11.

### Receiving Process in Positioning Mode

When it is determined No in SA13, the control device 40 determines whether or not there is the receiving operation in the positioning mode where the button 74 is pressed for the second setting period of time (longer than six seconds) (SA18).

When it is determined No in SA18, the control device 40 returns to the process in SA11.

In contrast, when it is determined Yes in SA18, the positioning unit 420 executes the receiving process in the positioning mode (SA20).

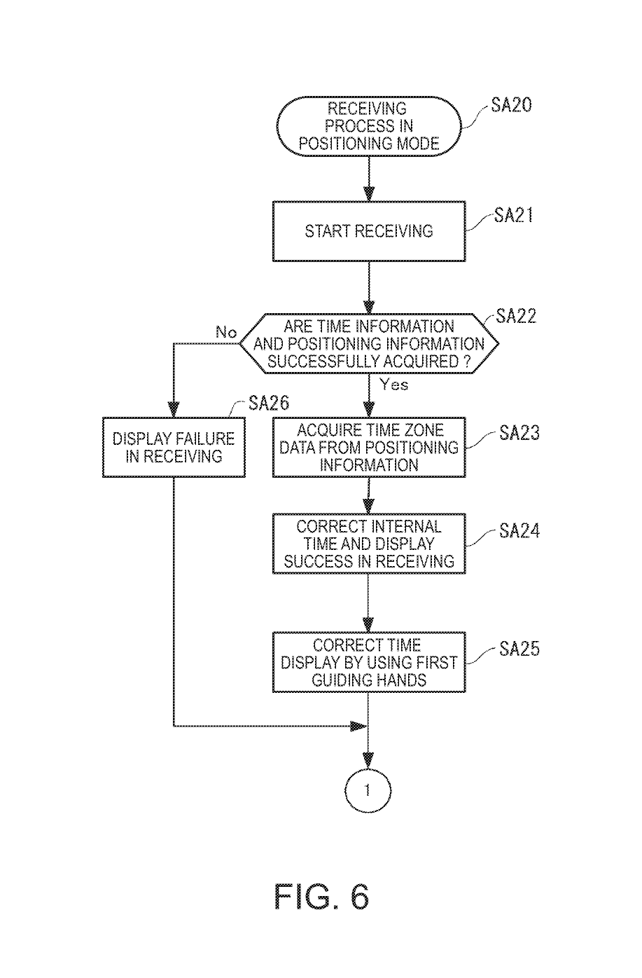

Next, the receiving process SA20 in the positioning mode is illustrated in FIG. 6.

The positioning unit 420 first starts the receiving process in the positioning mode (SA21).

After the receiving process is started in SA21, the control device 40 determines whether or not the time information and the positioning information are successfully received (SA22).

### Time Correction Process in Positioning Mode

When determining that the time information and the positioning information are successfully received by the receiving process (SA22: case of Yes), the control device 40 acquires the time zone data corresponding to the acquired positioning information from the time zone data storage unit 680 and corrects the time zone data 650 (SA23).

In addition, the control device 40 corrects the internal time data 630 by using the acquired time information and corrects the time data for timepiece display 640 in new time zone data 650. Furthermore, the control device 40 moves the second-hand 121 to a predetermined position and displays that the receiving is successful (SA24). This display of the success in the receiving is also performed for a predetermined period of time, for example, five seconds. At this time, if the time zone data 650 and the internal time data 630 are corrected, the control device 40 also corrects the time data for timepiece display 640.

If the display of the success in the receiving for the predetermined period of time is completed, the control device 40 corrects the display time using the first hands 12, based on the time data for timepiece display 640 (SA25). In this manner, even when travelling to a country having the different time zone by plane or the like, the display time of the first hands 12 can be automatically corrected to the time of the current location (local time).

The second hands 13 which are set to be operated independently from the first hands 12 are not corrected in conjunction with the correction of the first hands 12 even when the time zone data 650 is corrected. Therefore, the second hands 13 can always display the home time.

In contrast, when it is determined No in SA22 (in a case where the receiving fails), the control device 40 moves the second-hand 121 to a predetermined position via the drive mechanism 210 and displays that the receiving fails (SA26). This display of the failure in the receiving is also performed for a predetermined period of time, for example, five seconds.

If the processes in SA25 and SA26 are completed, the control device 40 completes the receiving process SA20 in the positioning mode, and returns to the process in SA11 of FIG. 5. Therefore, until it is determined Yes in either SA11, SA13 or SA18, the control device 40 maintains a standby state where the receiving process is not started.

### Advantageous Effect of First Embodiment

According to the present embodiment, the following advantageous effect can be obtained.

The electronic timepiece 1 includes two time display units of the first hands 12 which configure the first time display unit 110 and the second hands 13 which configure the second time display unit 120. Therefore, the first hands 12 can display the local time and the second hands 13 can display the home time.

Then, if the positioning unit 420 acquires the positioning information of the current location and the time zone setting unit 430 sets the time zone data 650 of the current location, the time zone correction unit 440 corrects the first time guided by the first hands 12 by using the time zone data 650. Accordingly, when the user wearing the electronic timepiece 1 travels to a country having the different time zone by plane, the positioning unit 420 acquires the positioning information. In this simple manner, the first hands 12 can display the first time, that is, the local time of the current location.

In contrast, even when the time zone data 650 is set, the time zone correction unit 440 does not correct the second time guided by the second hands 13. Therefore, the second hands 13 can always display the home time.

Accordingly, the first hands 12 can easily display the local time of the current location and the second hands 13 can always display the home time set by the user. Therefore, even when travelling abroad, it is possible to easily confirm the time of the user's hometown.

In addition, a display area of the first time display unit 110 configured to have the first hands 12 and the main dial 111 is adapted to be larger than that of the second time display unit 120 configured to have the second hands 13 and the sub-dial 112. Thus, the local time is easily visible. Therefore, it is possible to provide the convenient electronic timepiece 1.

In addition, in this configuration, the receiving process is performed in the timing mode during the automatic receiving process and the receiving in the positioning mode where the receiving time is longer is executed only when the button 74 is pressed for the second setting period of time. In this manner, the receiving process of the positioning mode is executed only when the user of the electronic timepiece 1 intentionally performs the receiving operation. Therefore, without having to continue the receiving for a long period of time in a state where the satellite signal cannot be received, it is possible to prevent the power from being significantly consumed.

### Second Embodiment

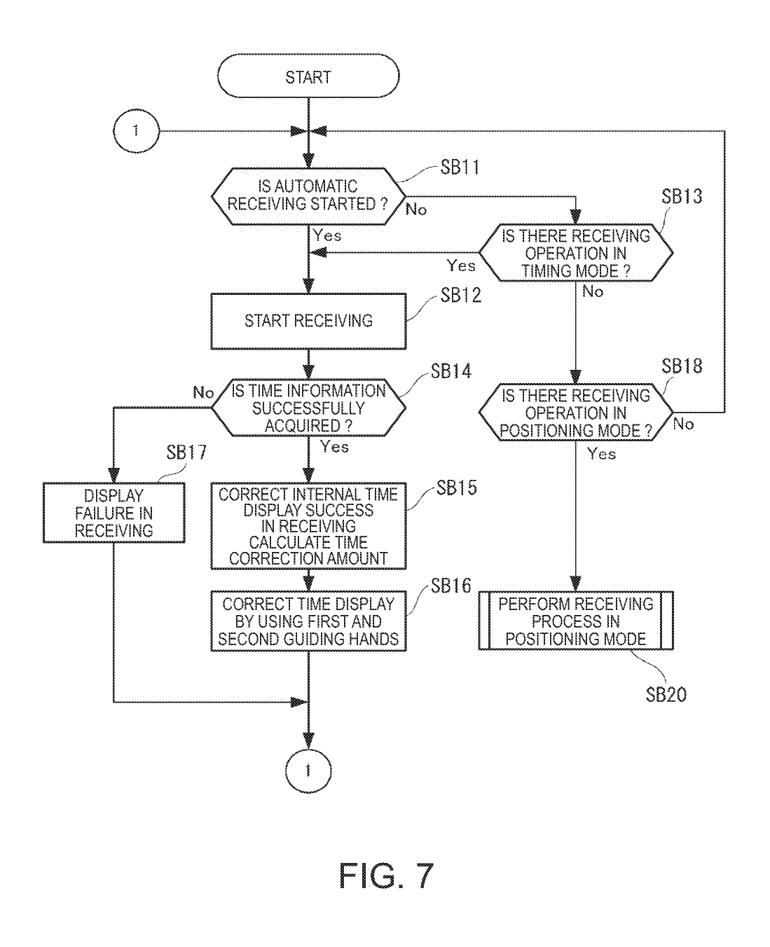

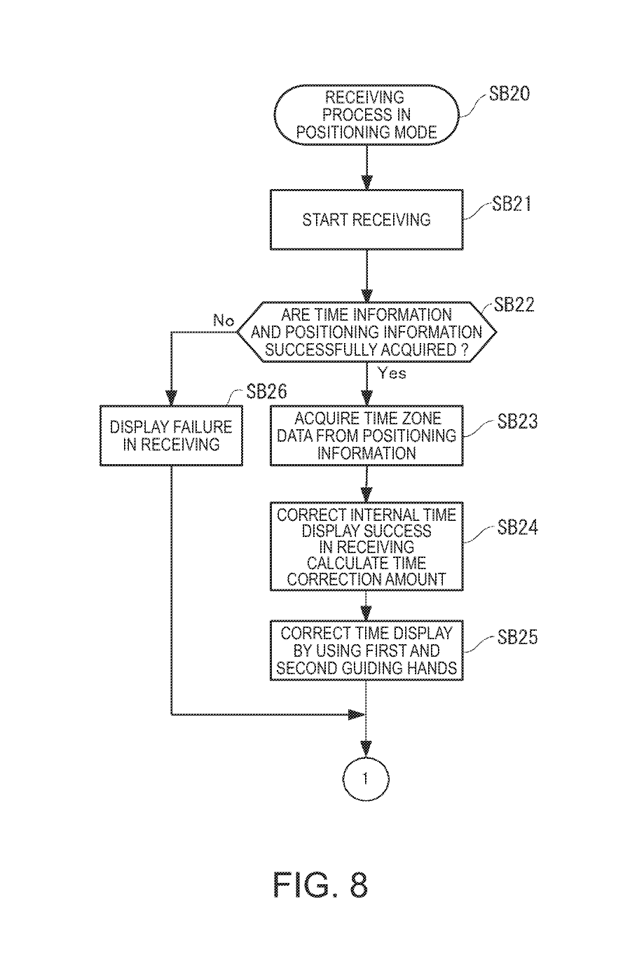

Next, a second embodiment of the invention will be described with reference to FIGS. 7 and 8. The second embodiment is the same as the first embodiment except for a time display correction process by using the second hands 13, and thus description thereof will be omitted.

In the first embodiment, the second hands 13 are operated independently from the first hands 12, and the second hands 13 are not corrected even when the first hands 12 are corrected. In contrast, in the second embodiment, the second hands 13 are operated in conjunction with the internal time data 630, that is, the first hands 12. That is, if the time data of the internal time data 630 is changed by the reference signal from the timing device 50, the second hands 13 in addition to the first hands 12 are also operated in conjunction therewith. The second hands 13 do not include the second-hand, but are formed to have the minute hand 131 and the hour hand 132. Accordingly, the second hands 13 are not operated for every second, but are operated for every 20 seconds, for example.

Here, the hand position detection mechanism which detects a hand position of the first hands 12 is disposed similar to the first embodiment. In contrast, the hand position detection mechanism which detects a hand position of the second hands 13 is not disposed similar to the first embodiment. Therefore, the time data (UTC) of the internal time data 630 is not coincident with the time which is actually guided by the second hands 13, and thus the second hands 13 are operated by using the time difference which is manually set. For example, when the internal time data 630 (UTC) is zero second, zero minute, one o'clock, the second hands 13 are set to be zero second, zero minute, ten o'clock by the manual operation. In this case, the second hands 13 are set to have the time difference of plus nine hours with respect to the internal time data 630 by the manual operation.

Thereafter, in conjunction with the receiving time data 610 and the internal time data 630 being updated by the reference signal from the timing device 50, the second hands 13 are also operated.

In addition, if the timing unit 410 or the positioning unit 420 receives the time information, the receiving time data 610 is updated by the received time information and the internal time data 630 is also updated in conjunction therewith, the second hands 13 are also moved in conjunction therewith by the time correction amount of the internal time data 630.

For example, when the internal time data 630 (UTC) is 40 seconds, 25 minutes, three o'clock and the time guided by the second hands 13 is 40 seconds, 25 minutes, 12 o'clock, the internal time data 630 is updated to zero second, 26 minutes, three o'clock by using the received time information. In this case, the time correction amount of the internal time data 630 is plus 20 seconds. Therefore, the second hands 13 are also ahead by 20 seconds and guide zero second, 26 minutes, 12 o'clock.

A receiving process in the second embodiment in which the above-described control for operating the hands is performed is illustrated in FIGS. 7 and 8.

As illustrated in FIGS. 7 and 8, the control device 40 performs processes in SB11 to SB26. Here, the processes except for SB15, SB16, SB24 and SB25 are the same as those of the first embodiment, and thus description thereof will be omitted.

When the time information is successfully acquired in SB14, the control device 40 of the second embodiment performs the correction process of the internal time and the display of the success in the receiving similar to the first embodiment. Furthermore, as described above, the control device 40 additionally performs a process for calculating a time correction amount from the time difference before and after the internal time data 630 is corrected (SB15).

Then, the time correction unit 450 corrects the first hands 12 to match the time data for timepiece display 640 which can be obtained by adding the time difference information to the internal time data 630, and corrects the second hands 13 according to the time correction amount (SB16). That is, the first hands 12 and the second hands 13 are operated by the correction amount of the same internal time data 630, and thus are corrected in conjunction with each other.

Similarly, in the receiving process SB20 of the positioning mode, when the time information and the positioning information are successfully acquired in SB22, the control device 40 performs a calculation process for obtaining the time correction amount in addition to the correction process of the internal time and the display process of the success in the receiving in SB24.

Then, the time correction unit 450 corrects the time display using the first hands 12 and the second hands 13 in SB25. At this time, the display time of only the first hands is corrected by the time zone data acquired from the positioning information in SB23. The second hands 13 are corrected by the time correction amount of the internal time data 630.

For example, it is assumed that the user of the electronic timepiece 1 stays in New York, the time zone data is set to have the time difference with minus five hours of Eastern Standard Time of America (EST) and the second hands 13 are set to be Japan Standard Time (JST).

Here, when the internal time data 630 (UTC) is 50 seconds, 25 minutes, six o'clock, the time guided by the first hands 12 is 50 seconds, 25 minutes, one o'clock (EST), and the time guided by the second hands 13 which are manually set is 50 seconds, 25 minutes, 15 o'clock (JST), it is assumed that the receiving process is performed in the positioning mode in Germany to which the user travels on a business trip.

As a result, it is assumed that the received time information allows the internal time data 630 (UTC) to be updated to be 55 seconds, 25 minutes, six o'clock and the time zone data obtained from the positioning information is set to have plus one hour (Central European Time: CET).

In this case, since the time correction amount of the internal time data 630 is plus five seconds, the second hands 13 are also ahead by plus five seconds and guide 55 seconds, 25 minutes, 15 o'clock. In addition, since the time zone data is changed to have plus one hour, the time data for timepiece display 640 is 55 seconds, 25 minutes, seven o'clock, and the first hands 12 also guide 55 seconds, 25 minutes, seven o'clock.

### Advantageous Effect of Second Embodiment

According to the second embodiment as described above, the same advantageous effect can be obtained by the processes that are the same as those of the first embodiment. In addition, the following advantageous effect can be further obtained.

That is, in the second embodiment, the second hands are operated in conjunction with the first hands 12. Accordingly, when receiving the time information, it is possible to correct not only the first hands 12 but also the second hands 13. Therefore, when an error occurs in the reference signal of a quartz crystal resonator of the timing device 50 due to a temperature change, it is possible to accurately correct the time of the internal time data 630 by receiving the time information, and it is also possible to correct the guiding time of the second hands 13 in conjunction therewith. Therefore, as compared to the first embodiment, it is possible to improve the guiding accuracy of particularly the second hands 13.

In addition, when the time zone data 650 is changed by acquiring the positioning information, the first hands 12 have the display time corrected according to the time zone data 650, but the second hands 13 are not corrected by the time zone data 650. Therefore, the home time in which the second hands 13 is set by the manual operation can always be displayed. That is, the first hands 12 can be changed to the current location time (local time) each time the user travels to a country having the different time zone. However, the second hands 13 can always continue to display the time of the same country. Therefore, it is possible to improve the convenience of the user.

### Third Embodiment

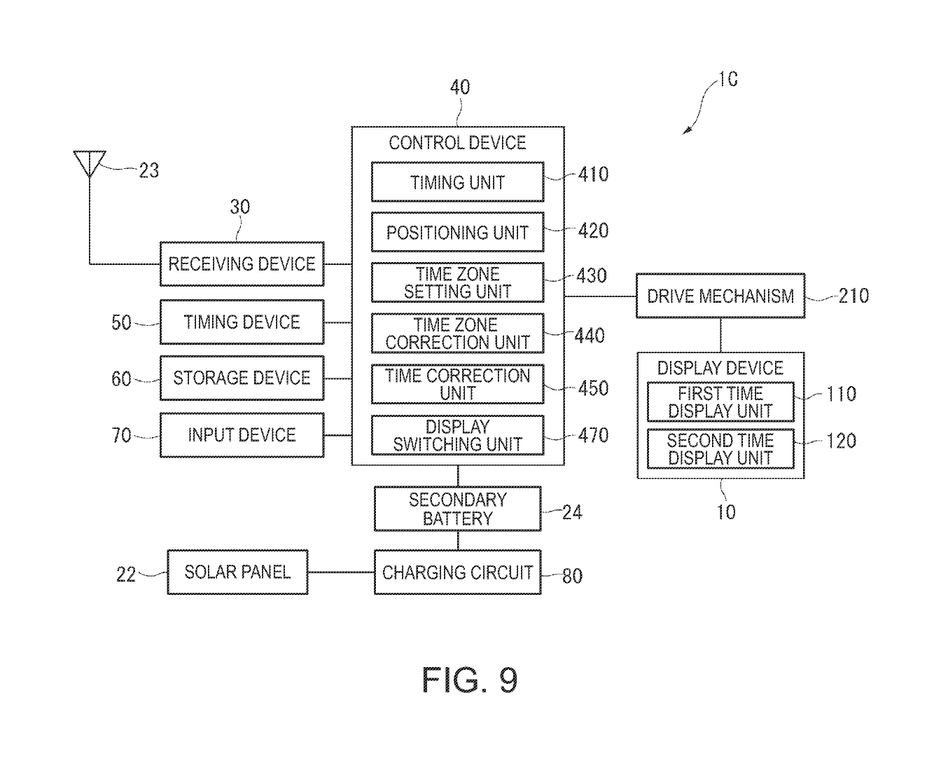

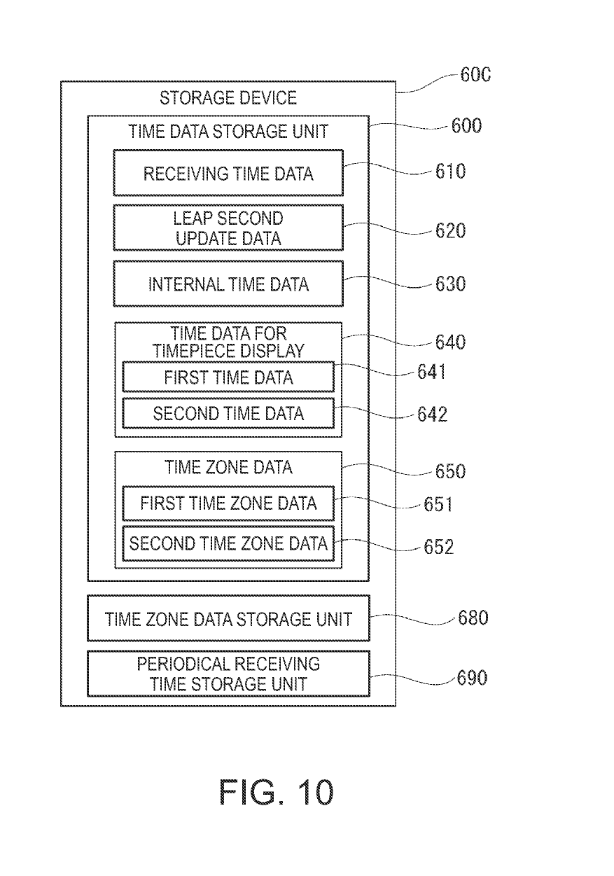

Next, a third embodiment of the invention will be described with reference to FIGS. 9 and 10. The third embodiment is the same as the first embodiment except that a display switching unit is added, and thus description thereof will be omitted.

As illustrated in FIG. 9, a control device 40 of an electronic timepiece 1C of the third embodiment has a display switching unit 470 added thereto compared with the electronic timepiece 1 of the first embodiment.

The display switching unit 470 is operated by the manual operation of the user, for example, when the button 74 is pressed for a third setting period of time (for example, six seconds) or longer. The display switching unit 470 switches between the first time guided by the first hands 12 and the second time guided by the second hands 13.

Therefore, as illustrated in FIG. 10, a storage device 60C of the electronic timepiece 1C includes first time data 641 as the time data for timepiece display 640, and second time data 642. In addition, as the time zone data 650, the storage device 60C includes first time zone data 651 and second time zone data 652.

Furthermore, there is provided a hand position detection unit that detects a hand position of the first hands 12 and the second hands 13, more specifically a state where the respective hands guide 12 o'clock position.

The first time data 641 and the second time data 642 are time data which is the display time of the first hands 12 and the second hands 13. In addition, the first time zone data 651 and the second time zone data 652 are time zone data (time difference information) which is set to be the display time of the first hands 12 and the second hands 13. Accordingly, the first time data 641 and the second time data 642 are calculated by adding the first time zone data 651 and the second time zone data 652 to the internal time data 630 (UTC).

In the electronic timepiece 1C as described above, the first time and the second time are set by the following operation. That is, similar to the first embodiment, if the positioning unit 420 performs the receiving process in the positioning mode and acquires the positioning information, the time zone setting unit 430 reads out the time zone data of the current location from the time zone data storage unit 680, and sets the time zone data in the first time zone data 651. In addition, if the receiving time data 610 is updated by the acquired time information, the internal time data 630 is also corrected. Accordingly, the first time data 641 is corrected by the internal time data 630 and the first time zone data 651.

The first time data 641 is in synchronization with the first hands 12 by the hand position detection unit. Thus, if the first time data 641 is corrected, the first hands 12 are also corrected to guide the time of the first time data 641. Accordingly, for example, if the positioning unit 420 is operated in Japan, the time difference of plus nine hours is set in the first time zone data 651, thereby causing the first hands 12 to guide Japan Standard Time.

Then, if the button 74 is pressed for the third period of time or longer and the display switching unit 470 is operated, the display switching unit 470 switches over to the first time and the second time. More specifically, the first time zone data 651 and the second time zone data 652 are switched over to each other, thereby switching over the first time data 641 and the second time data 642.

For example, when the time difference of plus nine hours in Japan Standard Time is set in the first time zone data 651 and the second time zone data 652 is an initial value (time difference is zero hour), if the display switching unit 470 is operated, the first time zone data 651 is the initial value (time difference is zero hour) and the second time zone data 652 has plus nine hours.

Therefore, the first time data 641 is the time of UTC, and the first hands 12 also guide UTC. In contrast, the second time data 642 is the time of JST, and the second hands 13 guide JST.

When the user travels to New York, if the positioning unit 420 performs the receiving process in the positioning mode, the time difference of minus five hours in Eastern Standard Time in America (EST) is set in the first time zone data 651, and the first hands 12 guide the time of EST.

At this time, if the display switching unit 470 is operated, the second time zone data 652 remains unchanged to be JST, and the second hands 13 continue to guide the time of JST.

Then, when the user returning to Tokyo from New York by plane, for example if the user operates the display switching unit 470 in the plane, the first time and the second time are switched over to each other. Thus, without performing the receiving process in the positioning mode, the first hands 12 guide the time of JST and the second hands 13 guide the time of EST. Therefore, in the plane, the user can easily adjust the first hands 12 to the arrival time in Japan.

### Advantageous Effect of Third Embodiment

According to the third embodiment as described above, the same advantageous effect can be obtained by the processes that are the same as those of the first embodiment. In addition, the following advantageous effect can be further obtained.

There is provided the display switching unit 470 which switches over the first time and the second time. Accordingly, in the user's home country which is the user's living base, by performing the receiving process in the positioning mode and by further operating the display switching unit 470, the user can adjust the second time zone data 652, that is, the second time displayed by the second hands 13 to the home time. Therefore, as described in the first embodiment, since it is not necessary to adjust the time of the second hands 13 by the manual operation, it is possible to easily and accurately adjust the second hands 13 to the home time, and it is possible to improve the convenience.

Furthermore, if the time zone of a current destination country (for example, home country) is set to be the second time (second time zone data 652), without performing the receiving process in the positioning mode before travelling to the country, it is possible to adjust the first time guided by the first hands 12 to the time of the country by simply operating the display switching unit 470. Therefore, it is possible to display the local time of the destination during the travelling in the plane, and it is possible to improve the convenience.

### Fourth Embodiment

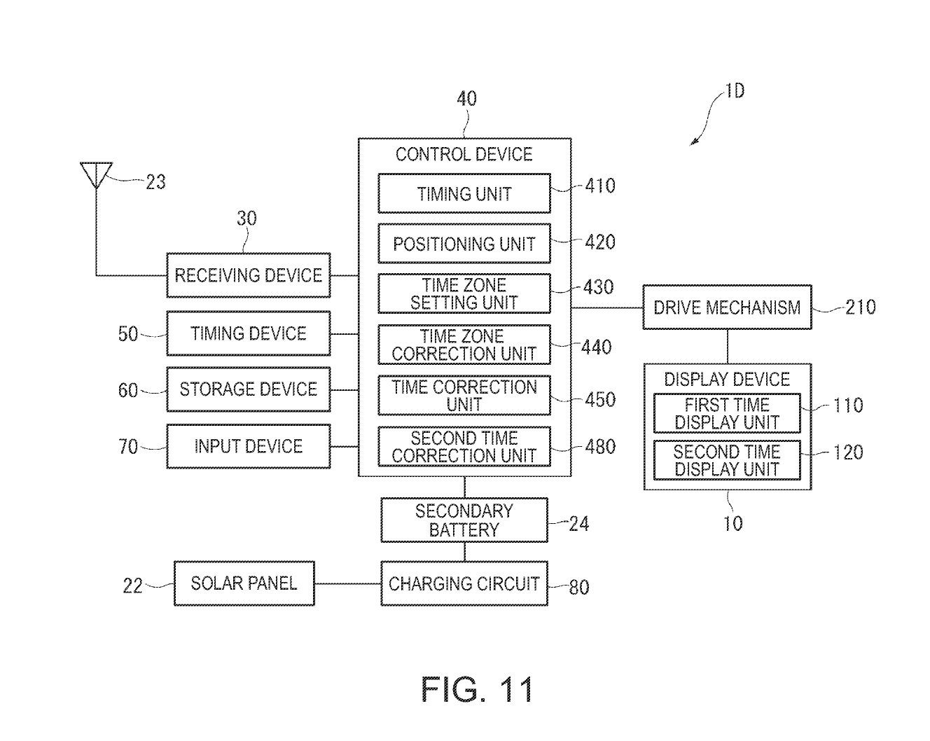

Next, an electronic timepiece 1D of a fourth embodiment of the invention will be described with reference to FIG. 11. The electronic timepiece 1D of the fourth embodiment is the same as the electronic timepiece 1C of the third embodiment except that a second time correction unit 480 is disposed instead of the display switching unit 470 of the third embodiment, and thus description thereof will be omitted. In the fourth embodiment, the display switching unit 470 may also be disposed.

Here, the second time correction unit 480 is executed by a predetermined button operation, and corrects the first time to be the second time. That is, whereas the display switching unit 470 performs two-way correction in which the first time and the second time are switched over to each other, the second time correction unit 480 performs one-way correction in which the second time is updated by the first time.

Therefore, the electronic timepiece 1D of the fourth embodiment includes the storage device 60C similar to the third embodiment. Then, if the second time correction unit 480 is operated, the second time zone data 652 is updated by a setting value of the first time zone data 651. Therefore, unless the receiving process in the positioning mode is subsequently performed and the first time zone data 651 is updated to new time zone data, the first time zone data 651 and the second time zone data 652 are the same as each other, and the second time data 642 is also the same as the first time data 641.

### Advantageous Effect of Fourth Embodiment

According to the fourth embodiment as described above, the same advantageous effect can be obtained by the processes that are the same as those of the first embodiment. In addition, the following advantageous effect can be further obtained.

There is provided the second time correction unit 480 which corrects the second time by using the first time. Accordingly, in the user's home country which is the user's living base, by performing the receiving process in the positioning mode and by further operating the second time correction unit 480, the user can adjust the second time zone data 652, that is, the second time displayed by the second hands 13 to the home time. Therefore, as described in the first embodiment, since it is not necessary to adjust the time of the second hands 13 by the manual operation, it is possible to easily and accurately adjust the second hands 13 to the home time, and it is possible to improve the convenience.

### Another Embodiment

The invention is not limited to the configuration of the respective embodiments. Various modifications can be made within the scope of the invention.

For example, in the respective embodiments, the first time display unit 110 is configured so that the display area is larger than that of the second time display unit 120. However, each of the time display units may be set to have the display area the same as each other or the second time display unit 120 may be configured so that the display area is larger than that of the first time display unit 110.

In addition, the first time display unit 110 and the second time display unit 120, without being limited to those which include the first hands 12 and the second hands 13, may be configured so that any one display unit or both display units have a digital display unit such as a liquid crystal display unit.

In the respective embodiments, there are two time display units of the first and second time display units. However, three or more time display units may be provided. In this case, it is possible to display three or more types of time.

In addition, in the third embodiment, when three or more types of time display units are provided, each time the display switching unit 470 is operated, the switching between the first time and the second time, and the switching between the second time and the third time may be sequentially performed. Similarly, in the fourth embodiment, when three or more types of time display units are provided, each time the second time correction unit 480 is operated, the correction of the second time by using the first time, and the correction of the third time by using the second time may be sequentially performed.

In the respective embodiments, the positioning unit 420 also acquires the time information in addition to the positioning information. However, only the positioning information may be set to be acquired. In this case, the time zone setting unit 430 corrects only the time zone data 650 and the time zone correction unit 440 corrects the time data for timepiece display 640, that is, only the display time of the first hands 12.

In addition, in the embodiments, the GPS satellite has been described as the positioning information satellite. However, in addition to the GPS satellite, the positioning information satellite according to the invention may include positioning information satellites which transmit the satellite signal containing the time information of stationary satellites in other Global Navigation Satellite Systems (GNSS) such as the Galileo (EU), the GLONASS (Russia) and the BeiDou (China) or SBAS, and quasi-zenith satellites.

The electronic timepiece according to the invention is not limited to those which include the receiving device 30 receiving the satellite signal of the GPS satellite 100. The invention can also be used in the electronic timepiece having a device requiring large power consumption, such as a device for wireless communication with other electronic devices. In addition, the electronic timepiece is not limited to the wristwatch. For example, the invention can be widely used in a device having a timepiece mechanism which requires large power consumption and is portably used, such as mobile phones and portable GPS receivers used when climbing.

The entire disclosure of Japanese Patent Application No. 2013-40418, filed Mar. 1, 2013 and of Provisional Application No. 61/771,313, filed Mar. 1, 2013 is expressly incorporated by reference herein.

What is claimed is:

1. An electronic timepiece comprising:
a positioning unit that receives a satellite signal transmitted from a positioning information satellite and acquires positioning information of a current location;
a time display unit that has at least a first time display unit for displaying a first time and a second time display unit for displaying a second time; and
a time zone correction unit that corrects the first time using time zone information corresponding to the positioning information and that does not correct the second time using the time zone information.

2. The electronic timepiece according to claim 1, further comprising:
a timing unit that receives the satellite signal transmitted from the positioning information satellite and acquires time information; and
a time correction unit that corrects the first time and the second time if the timing unit acquires the time information.

3. The electronic timepiece according to claim 1,
wherein the second time display unit has a display area which is smaller than that of the first time display unit.

4. The electronic timepiece according to claim 1, further comprising:
a display switching unit that switches over the time information displayed by the first time display unit and the time information displayed by the second time display unit to each other.

5. The electronic timepiece according to claim 1, further comprising:
a second time correction unit that corrects the second time displayed by the second time display unit so as to be the first time displayed by the first time display unit.

6. A time correction method of an electronic timepiece that has at least a first time display unit for displaying a first time and a second time display unit for displaying a second time, the method comprising:
receiving a satellite signal transmitted from a positioning information satellite and acquiring positioning information of a current location; and
correcting the first time using time zone information corresponding to the positioning information and of not correcting the second time using the time zone information.
